(19) United States
(12) Patent Application Publication
(10) Pub. No.: US 2014/0203650 A1
(43) Pub. Date: Jul. 24, 2014

(54) SYSTEM FOR THE GENERATION, STORAGE AND SUPPLY OF ELECTRICAL ENERGY PRODUCED BY MODULAR DC GENERATORS, AND METHOD FOR MANAGING SAID SYSTEM

(71) Applicant: Alessandro Striuli, Mestre (IT)

(72) Inventor: Alessandro Striuli, Mestre (IT)

(73) Assignee: SISVEL TECHNOLOGY S.R.L., None (TO) (IT)

(21) Appl. No.: 14/237,607

(22) PCT Filed: Aug. 10, 2012
(86) PCT No.: PCT/IB2012/054084

§ 371 Date: Apr. 1, 2014

(30) Foreign Application Priority Data
Aug. 11, 2011 (IT) TO2011A000762

(51) Int. Cl. H02J 7/34

(52) U.S. Cl. CPC H02J 7/34
USPC 307/66

(57) ABSTRACT

A system for generating and using (for storage and supply of) electric energy produced by modular direct-current electric energy sources, which includes: a system of interconnected modules for the production of direct-current electric energy which is positioned upstream of one or more systems for using electric energy through DC/AC conversion; a system of interconnected elements for storage and supply of electric energy produced by the energy production modules which is positioned upstream of the one or more systems for using electric energy; at least one electronic control unit, adapted to manage the interconnections among the modules and the interconnections among the elements, so that at least some of the interconnected modules can deliver electric energy directly to at least some of the storage and supply elements, and/or to the one or more systems for using electric energy, and so that at least some of the elements can supply electric energy directly to the one or more systems for using electric energy.

### FIELD OF THE INVENTION

The invention relates to a system for generating, managing and using electric energy produced by modular direct-current electric energy sources, and to a method for managing said system.

### BACKGROUND ART

Most electric energy production systems still consist of large power plants for which significant problems of energy transportation and distribution must be faced, in the sense that it is very important to minimize losses along the lines, which are run by quite regular unidirectional currents. The energy is transported at high voltage along most of the path. In the future, however, an increasingly significant part of electric energy will be produced in small quantities, and therefore it will necessarily be supplied to the network at medium or low voltage; it will thus be very important to minimize the transformations and transportation undergone by the produced energy. In the ideal condition, there are territorially compact “energy islands” in which energy production and usage roughly match, and in which energy exchanges between islands, in particular between non-adjacent ones, are reduced to a minimum.

Hence there will be many energy contributions produced in small quantities, both because there will be many small systems and because the biggest plants will be allowed to produce less energy.

Reference will be made in the following, by way of example, to electric energy produced by photovoltaic conversion systems. In fact, the photovoltaic energy source exemplifies in a very effective manner the problems that will have to be faced as Renewable Energy Sources (hereafter also referred to as FER) and “island” type network infrastructures become widespread. Similar problems may also arise for other energy sources suited to distributed diffusion and having operating characteristics similar to those of photovoltaic systems, such as systems for the production of energy from renewable sources based on photo-electrochemical conversion of solar energy.

Or, more in general, for modular direct-current electric energy sources, such as, for example, direct-current (DC) dynamo micro-aeolian plants, or systems for transforming mechanical energy into direct-current electric energy, etc.

As a consequence, many of the conclusions that will be arrived at below will be also applicable in general, without being limited to the case of electric energy produced by photovoltaic systems, to these different types of systems involving non-programmable energy sources, for which it is not possible to plan a time-dependent production profile also including, in addition to power, the current-voltage characteristic.

As known, solar radiation covers the whole territory, and therefore the use of said radiation for producing electric energy is naturally distributed over the territory. Furthermore, since conversion efficiency is not especially high, in order to produce a significant quantity of energy a quite large area is generally required. It can therefore be foreseen that in the future such photovoltaic systems will be distributed over large territories, just like, for example, buildings fitted with roofings suitable for accommodating such systems.

Even though weather forecasts may be subject to further improvements, so that it will be easier to know if a day will be more or less sunny, it will never be realistically possible to have a forecast of the instantaneous production profile of a photovoltaic system, which, when the sky is cloudy, is characterized by huge variations (even from maximum output to low or null output) within a few seconds, when, for example, the sun is shaded by fast moving clouds. Moreover, even if an instantaneous production profile were possible, it is definitely impossible to obtain a consumption profile capable of following the quick production variations which are typical of a photovoltaic system.

It is therefore clear that the network balance problem will become more and more important as the share of energy produced by non-programmable sources grows (such as those exploiting spontaneous natural phenomena that cannot be planned or forced, like photovoltaic systems). The network balance concept is an instantaneous concept, i.e. the network must be balanced instant by instant, and any opposite-sign unbalances, even in quick succession, will not compensate each other, but will be added together in terms of negative effects upon the integrity of the electric system.

It is known that an attempt has been made to solve the balance problem by using Energy Storage Systems (hereafter also referred to as SAE). Such systems can absorb and store energy as it is being produced, and can make it available to loads when required. Currently, a renewable energy production system of a known type based on photovoltaic energy is made up of a certain number of solar panels connected to an inverter system that converts the energy, intrinsically produced by the panels in the form of direct voltage, into alternating voltage that can be used by local user apparatuses or yielded, still in alternating form, to the public energy distribution network.

The inverter system, therefore, receives the generated energy as direct voltage and converts it into alternating voltage by adapting the load seen by the source to the power, in terms of current-voltage pair (I-V), generated by the panels instant by instant. This typically occurs with control systems based, for example, on processing carried out according to MPPT (Maximum Power Point Tracking) algorithms. This solution has some drawbacks:
direct-alternating voltage conversion causes conversion losses;
for certain intervals of the current and voltage values, the inverter cannot operate or can only operate at low efficiency levels, so that the energy generated by the FER is completely or partially dissipated;
in particular conditions or at particular times, the network may not be able to absorb the energy generated by the system, so that it is forced to stop the flow thereof, resulting in a loss.

This last situation typically arises when lighting is poor or anyway insufficient (dawn, sunset, fog, mist or cloudy sky).

This typical configuration, wherein all the energy produced is directly converted into alternating voltage, proves to be inefficient when loads must use direct voltage, in that a double conversion is required in order to obtain direct voltage again.

However, this lack of efficiency has so far been considered to be of little importance, because typical loads use alternating voltage and most of the energy produced is yielded to the network. This will change in the near future, because the networks will not be able to absorb increasing quantities of energy produced in an unplanned manner without suffering from unbalance problems.

Consequently, downstream of the production systems it will be necessary to insert energy storage systems SAE, and the latter are similar, when charging, to DC loads.

Anyway, even in the typical configurations between photovoltaic system and inverter, wherein the burden of the adaptation between the FER and the inverter is wholly borne by the latter, when energy production falls below a certain threshold the direct-current electric energy cannot be converted into alternating current and is therefore lost.

Attempts have been made in the prior art to introduce flexibility by using flexible configuration techniques. In these cases, since a solar panel system is typically organized in arrays, when some panels are occasionally shaded and their production falls drastically compared to the other unshaded panels, such panels are excluded from production; however, this exclusion normally involves the whole array to which such panels belong: such a measure therefore causes a waste of energy, in that other panels of the disconnected array could still produce energy effectively.

To overcome this kind of losses, a method is known which has been described in the article “An Adaptive Photovoltaic-Inverter Topology—Mahamoud A. Alahmad et al., University of Nebraska (USA), 2011-IEEE 978-1-61284-220-2/11”. This article proposes the use of different inverters having different characteristics, which are connected in a programmable manner to arrays of solar panels so as to widen the range of lighting values for which the system keeps producing energy, compared to a normal photovoltaic system with a fixed configuration. Aiming at optimizing the coupling between photovoltaic system and inverter, the length of the arrays, which determines the system's output voltage, is configured in a flexible manner, with longer arrays when production decreases and shorter arrays when production increases. According to this known method, flexible series-parallel circuits are normally made by using switching matrices, as shown in FIG. 1, which represents a typical case wherein the photovoltaic modules can be connected to a switching matrix that allows modifying the various connections.

This connection method based on a switching matrix has the drawback, however, that much wiring is required because the single photovoltaic modules must be fitted with wires covering the distance between themselves and the switching matrix. It is apparent that, for larger photovoltaic systems, such wiring becomes rather time-consuming and costly (it must be pointed out in this regard that switching matrices also become rather complex systems as the matrix size grows). In addition, the solution proposed in the above-mentioned article requires multiple inverters, so that there are still losses due to DC/AC energy conversion.

Anyway, this solution does not solve the problem of compensating for the very fast unbalances determined by the panels' illumination conditions, which may cause sudden variations in the electric energy output of the system.

The currently most widespread configuration of a modular direct-current energy production system uses single modules (panels) connected in fixed arrays. Each array includes a fixed number of modules connected in series, and said arrays are then connected in parallel to one another. The output of this series-parallel combination is connected to an inverter, which transforms the input energy into alternating current that can be either yielded to the network or used by common AC loads. It is clear that neither the power values nor the current-voltage characteristics of the production plant are constant, since they may change from zero to peak values. It is for this reason that the inverter technology has evolved to include, in its input stages, adaptation mechanisms which are useful for having the inverter stages operate at high efficiency levels. It is also clear that the efficiency of such inverters is only optimal within a certain interval of input values, and that they offer lower performance levels outside said interval.

According to the most common and frequent configurations and, as aforesaid, when one also wants to use the SAE energy storage functionality, the energy is generally supplied to the SAE's in alternating form by interposing rectifying systems called battery chargers, which are generally quite expensive items characterized by an efficiency of less than 100%. It is apparent from the above that any known FER-SAE system suffers from adaptation and management problems, which are normally faced by using a certain number of DC-AC and AC-DC transformations and adaptations that allow each apparatus to operate in optimal conditions, even in the presence of a very variable initial energy source. It is also clear that every adaptation and transformation subsystem causes losses and reaches non-ideal operating points.

A theoretical alternative to the use of AC/DC battery chargers for creating optimal direct-current couplings with storage systems could be the use of DC/DC converters. However, this solution would add excessive costs that would be required in order to equip each module with a good-quality converter capable of operating within a sufficiently wide range of values. It must nevertheless be underlined that also such converting apparatuses do not have totally free input value tolerances.

A further aspect that may give rise to problems is that the future evolution of electric systems seems to go towards systems defined as “Smart Grids”, i.e. electric networks that will no longer be just “simple” transportation infrastructures, but will also incorporate energy management functions capable of automatically interacting with loads, production sources and energy storage systems SAE.

This “Smart Grid” concept, combined with the fact that many FER's are medium-to-small distributed energy sources, determines, as stated above, a thrust towards the diffusion of network architectures divided into “islands” or “energy districts”. Such “energy districts” are characterized by the use of computers, also referred to as controllers, for managing all aspects of the energy resource. The number of such computers, their physical location and the detailed functions that they must carry out are still the subjects of many proposals, and it should not be excluded that the actual future development of the “Smart Grid” concepts will be based on different architectural schemes from area to area and from operator to operator, without however affecting the potential effectiveness of the “Smart Grids” in terms of energy management.

A known example of a controller implementing a process for optimizing the energetic efficiency of an electric system that includes loads (more or less flexible), energy sources (FER) and energy storage systems SAE is described in patent US-7783390-B2. However, the electric system described therein requires that the energy storage systems SAE be positioned downstream of the inverters, thus giving rise to the above-mentioned problems relating to the presence of AC/DC converters for supplying power to the SAE's.

### SUMMARY OF THE INVENTION

It is therefore an object of the present invention to provide a system for generating and using (for storage and supply of) electric energy produced by modular direct-current electric energy sources, as well as a related method for managing said system, which are adapted to solve the above-mentioned problems.

The present invention relates to a system for generating and using (for storage and supply of) electric energy produced by modular direct-current electric energy sources, which comprises: a system of interconnected modules for the production of direct-current electric energy, said system of interconnected modules being positioned upstream of one or more DC/AC conversion systems; a system of interconnected elements for storage and supply of electric energy produced by said energy production modules (panels), said system of interconnected elements being positioned upstream of said one or more DC/AC conversion systems; at least one electronic control unit, adapted to manage the interconnections among said modules and the interconnections among said elements, so that at least some of said interconnected modules can deliver electric energy directly to at least some of said storage and supply elements, and/or to said one or more DC/AC conversion systems, and so that at least some of said elements can supply electric energy directly to said one or more DC/AC conversion systems.

Preferably in said system for generating and using (for storage and supply of) electric energy, said at least one electronic control unit is also configured in a manner such that said system of interconnected elements can deliver electric energy directly to a DC load system. Preferably in said system for generating and using (for storage and supply of) electric energy, said system of interconnected modules (panels) for the production of electric energy comprises two or more first arrays, each first array comprising one of said first electric lines, said at least one electronic control unit comprising means for determining parallel connections among said first arrays, or for subdividing groups of first arrays in parallel.

Preferably in said system for generating and using (for storage and supply of) electric energy, said system of interconnected elements for storage and supply of electric energy comprises two or more second arrays, each second array comprising one of said second electric lines, said at least one electronic control unit comprising means for determining parallel connections among said second arrays, or for subdividing groups of second arrays in parallel.

In particular, the present invention relates to a system for generating and using (for storage and supply of) electric energy produced by modular direct-current electric energy sources and to a method for managing said system as set out in detail in the appended claims, which are intended to be an integral part of the present description.

### BRIEF DESCRIPTION OF THE DRAWINGS

Further objects and advantages of the present invention will become more apparent from the following description of some preferred embodiments thereof, which is supplied by way of non-limiting example with reference to the annexed drawings, wherein:

FIG. 1 shows an example of a known system for interconnecting photovoltaic panels;

FIGS. 2 to 5 show some examples of a system for interconnecting photovoltaic panels according to the present invention;

FIGS. 6 and 7 show block diagrams of an interconnection between a renewable electric energy production system, an electric energy storage system and a control system in accordance with the present invention;

FIG. 8 shows an example of embodiment of a cell interconnection system of the electric energy storage system according to the invention;

FIG. 9 shows an example of an operational flow chart of the control system of the invention.

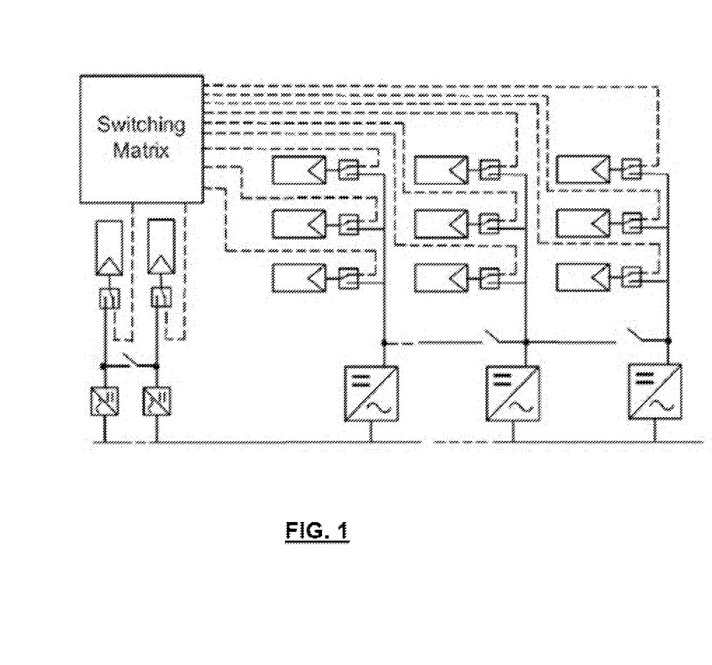

In the drawings, the same reference numerals and letters identify the same items or components.

### DETAILED DESCRIPTION OF SOME EMBODIMENTS OF THE INVENTION

Reference will be made below specifically to a non-limiting case wherein electric energy is produced by photovoltaic conversion systems. The scope of application of the invention is nonetheless intended to be also extended to systems for the production of energy from renewable sources based on photo-electrochemical conversion of solar energy.

More in general, the invention is meant to be applicable to modular direct-current electric energy sources, such as, for example, direct-current (DC) dynamo micro-aeolian plants, or systems for transforming mechanical energy into direct-current electric energy, etc.

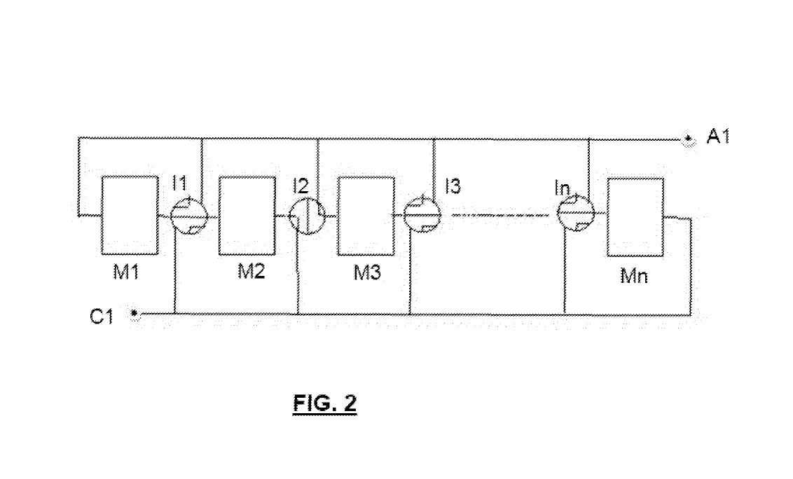

According to a first aspect, the invention exploits the fact that FER systems, in particular those made up of photovoltaic systems, are characterized in that they are generally made up of panels or modules which are rather small compared to the overall system dimensions. Such modules can be connected to one another in a manner such that they can be combined in series and/or in parallel with much flexibility. FIG. 2 shows how one can obtain such flexibility by simply actuating a certain number of switches.

FIG. 2 shows how the single modules M1, . . . Mn of a hypothetical circuit can be organized into variable-length arrays by actuating simple switches I1, . . . In. An “array” is intended a set of modules connected together in such a way that they show up to the outside, as a whole, with just two terminals. We can therefore imagine these modules to be arranged in a row, even though it is clear that said row may actually be compacted into some sort of coil in order to occupy the available space in a more rational way.

Depending on the instantaneous behavior of each module, it is possible to establish the number of consecutive modules to be connected in series, thereby determining the desired voltage, which is of the direct type, across the terminals of the circuit, identified as Anode A1 (positive terminal) and Cathode C1 (negative terminal). Once the desired number of consecutive modules to be connected in series has been reached, the series connection is stopped and, by appropriately operating the switch as shown in FIG. 2, one can bring the electrodes of two consecutive panels to the anode A1 and to the cathode C1 of the system, respectively, and then start building a new series (or array) of modules. All the various series (or arrays) thus built will therefore be connected in parallel to one another.

FIG. 2 shows in its upper and lower parts just one Anode and just one Cathode. It is nevertheless possible to conceive a system with 2, 3 or a generic number “N” of Anode-Cathode pairs, so organized that the whole assembly of modules can be partitioned into 2, 3 or “N” different sub-circuits or sections.

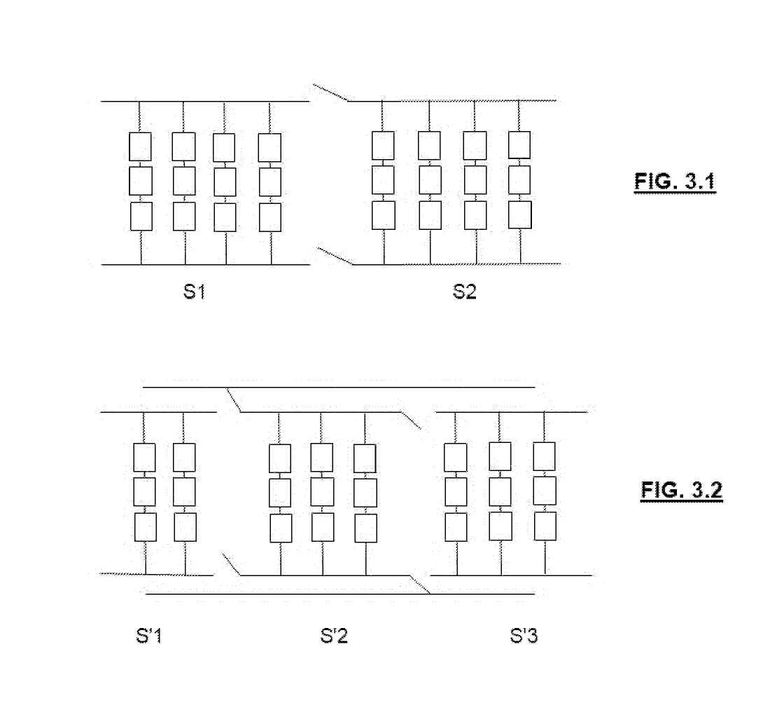

FIGS. 3.1 and 3.2 show examples of circuits that can be divided into 2 or 3 partitions. The case wherein the energy being produced is divided into two sections S1 and S2, as shown FIG. 3.1, is particularly simple. Sets of arrays of modules connected in parallel form one section, S1 or S2. In this case, it is sufficient to connect the two input/output terminals of each section at opposite Anode and Cathode ends and then open switches as necessary in order to separate the arrays in the desired proportion.

Also the partitioning into three sections S′1, S′2, S′3 (FIG. 3.2) can be done very easily by opening the Cathode and Anode conductors of the sections in two points instead of just one point as in the case of partitioning into two sections. In this case, another input/output terminal will be connected to a new pair of conductors.

It is apparent from the examples provided above that the number of partitions can be generalized by appropriately organizing the connections of the arrays.

Partitioning into more sections of arrays may be useful, for example, to supply the electric energy produced by the various sections to different users.

In the circuit diagram shown in FIG. 2 there are switches between the modules, and the wiring is much reduced in comparison with the prior-art case wherein all switches are concentrated within one matrix, but the laying of the system and the making of the connections thereof can be further simplified.

In fact, the scheme shown in FIG. 2 can be implemented in a very simple way by positioning the switches at the electrodes of each photovoltaic panel or module, thus integrating them into the panel itself.

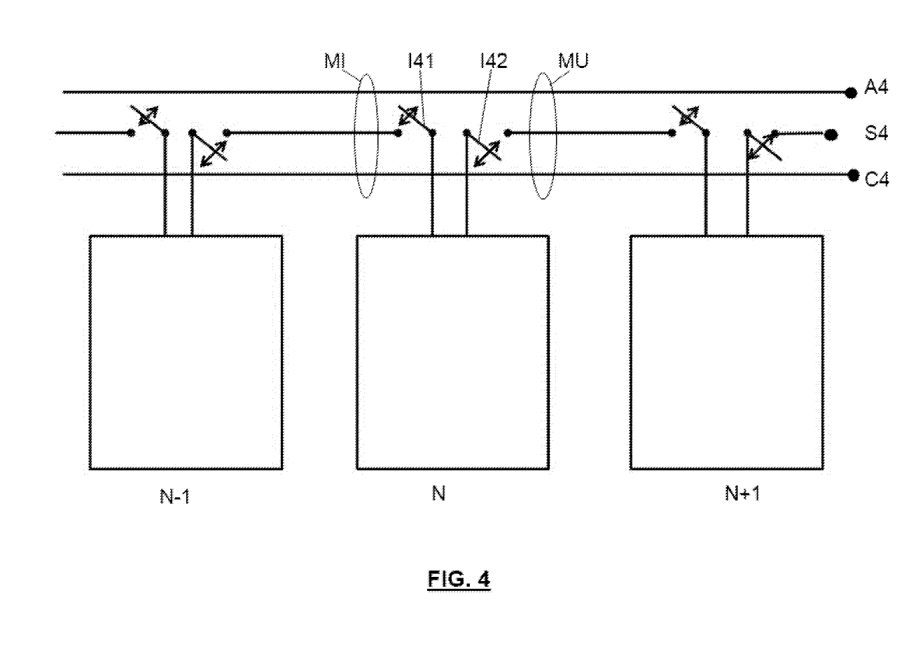

As shown in FIG. 4, it is sufficient that every single module N−1, N, N+1 includes one pair of simple two-way switches 141, 142 and has three input terminals MI and three output terminals MU (the figure shows those of module N). This feature proves to be particularly advantageous when laying large photovoltaic systems, which take up very large areas and for which simplicity of installation and maintenance is a very important factor; in such a case, the possibility of integrating the required switches into the module itself (without having to install them separately) is doubtlessly interesting.

The photovoltaic system can thus simply be laid by connecting the three output terminals of each panel, through a three-wire cable, to the three input terminals of the next panel. The three wires represent, respectively, the “anode line” A4, the “cathode line” C4, and the “array line” S4. The “array line” S4 is used for connecting the anode of a panel to the cathode of the adjacent panel when the two panels must be connected in series. The panels may also be all connected in parallel, by closing the anode of each panel on the anode line A4 and the cathode of each panel on the cathode line C4. In the typical case, however, series circuits are connected to one another in parallel. It is clear that the circuits to be connected in parallel (which in the case taken into account herein behave as generators) must all have their maximum efficiency point at the same voltage, for the purpose of limiting the onset of undesired currents. Normally, therefore, when the modules to be connected are all equal, it will be necessary to configure series circuits made up of the same number of modules, and then to connect all these series circuits in parallel to one another. It is of course possible that different modules are employed, for example illuminated in a heterogeneous way, such as solar panels mounted with different inclinations, for aesthetical reasons, in order to follow the surface of a building, or for using a different type of energy source. The modules' mutual connection, e.g. in parallel, will be in this case more complex but still feasible, and configurations will have to be found wherein all the circuits connected in parallel will have an optimal (or anyway acceptable) working point at the same voltage. Therefore, the cathode of each panel must be connected either to the anode of the adjacent panel through the “array line” S4, for a series connection, or to the “cathode line” S4, if that panel is the negative end of the array; instead, the anode of each panel must be connected either to the cathode of the adjacent panel, for a series connection, or to the “anode line” A4, if that panel is the positive end of the array.

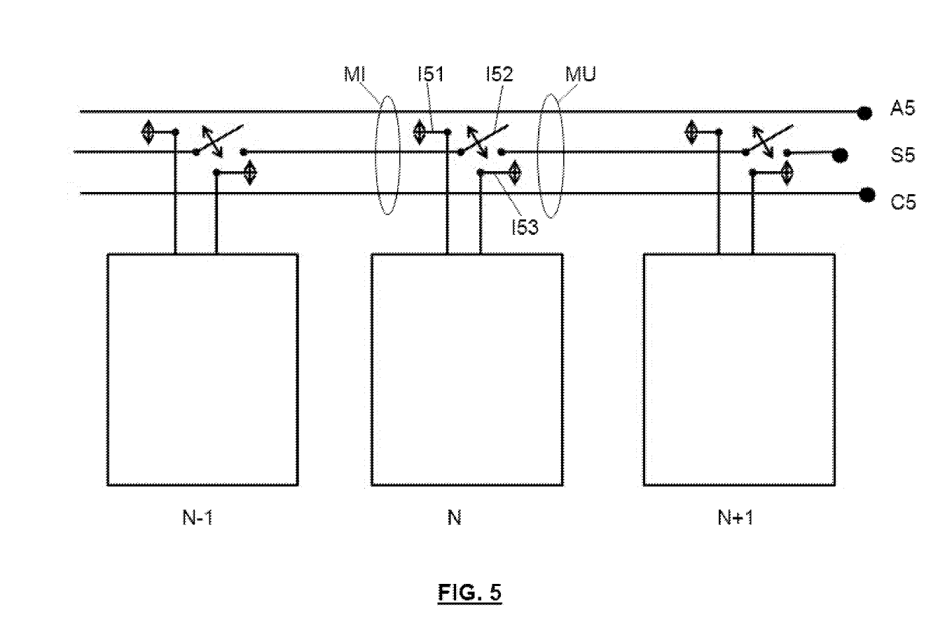

As shown in FIG. 5, by making the contact system slightly more complex and adding a switch it is also possible to disconnect a single panel.

The anode switch 151 and cathode switch 153 of a panel may also be set to a third position (in addition to those required according to the above description with reference to FIG. 4), in which they do not connect to any line: in such a case, the array line S5 must be closed by a suitable switch 152. When the switches are set in this manner, a panel is disconnected.

The known methods for disconnecting one panel (e.g. when shaded and/or damaged) would not allow restoring the optimal array length, and therefore these situations are handled in the prior art by excluding the whole array from the energy production process.

The switches can be controlled and managed remotely by a control system at the level of the “energy district” to which the system belongs. The switches may be easily operated through an electric command transported by the same line used for transferring the electric energy (e.g. the anode and cathode lines) by using per se known “conveyed wave” techniques (on Power Lines). It should be noted that the command to be sent to each switch is, in the simplest of cases, one bit.

Compared to traditional “Power Line” applications, wherein data are transferred by means of cables transmitting AC energy, this case appears to be simpler because DC energy is transmitted and can be separated very easily from any carrier, even at a relatively low frequency, used for data transmission. At any rate, one of the numerous standards already defined for this kind of applications can certainly be used for this purpose. By way of example, we can mention the IEEE P1901 standards or the standards defined by industrial alliances such as the “Universal Powerline Association” or the “HomePlug Powerline Alliance”.

Even though the transmission requirements of this application are extremely low and the “conveyed-wave” technique can certainly be used without any problems at all, it is nevertheless possible to employ an additional measure aiming at further reducing the noise. Since the switches need not be operated continuously or frequently, all commands can be transmitted to all switches without the latter switching immediately after having received the command, but after a preset delay or upon receiving a “trigger” signal. This avoids that, due to the switching of the first switches, noise transients are generated which might interfere with the transmission of the commands for the last switches.

With such a simple solution, it is possible to integrate said switches into the very structure of the panel during the manufacturing stage, with marginal additional costs. In this way, one can produce panels which can be easily connected and flexibly configured into series-parallel combinations.

In this case, the “cathode line” and the “anode line” will go through the “connection system” of each module and can be easily interrupted, so that they are suited to creating system partitions as previously described.

Of course, for more than two partitions it will be necessary to lay additional pairs of anode/cathode lines, as previously explained. It is therefore apparent that, if one wants to integrate the anode and cathode lines into the modules' structure (e.g. in order to avoid having to lay external wires), such lines (while being still integrated into the structure) will have to include two wires to allow partitioning into three sections, thus implementing the circuit diagram shown in FIG. 3.2. More numerous partitioning orders will require the anode and cathode lines to be implemented by using increasing numbers of conductive lines. Variants aiming at further reducing the required wiring are also possible by appropriately positioning (e.g. on opposite sides of the panel) the input and output terminal triples. It is also conceivable to equip the panel with complementary joint-type plugs and sockets which require no external wiring and which are also useful for reinforcing the mechanical coupling between the panels of the photovoltaic grid.

The switches may also be so configured as to allow the panel to be removed, e.g. in the event of a failure or for repair or replacement purposes. For example, the panel may be fitted with input and output connectors connecting the cathode, anode and array lines to the switches. When the switches are integrated into the panel, the connector will comprise connections so designed that, if the panel is removed, they will short-circuit the array line and open the connections with the anode and cathode lines. Or, when the switches are external to the panel, it will be sufficient to operate the switches as described above and disconnect the panel connectors.

Implementing such circuit variants is within the grasp of the man skilled in the art.

In general, it can be stated that, given a set of photovoltaic panels, they can be organized by connecting them in a flexible manner for the purpose of having a predefined number of outputs over which the power being generated or absorbed can be distributed by controlling the current and voltage thereof, said control being feasible with the accuracy given by the current and voltage characteristics of the single generating elements.

It has been shown how, by applying the aforementioned techniques for flexible array configuration, even a classic FER, such as a photovoltaic system, can be configured in such a way as to output a controllable voltage, the accuracy of the output voltage depending on the operating voltage of the single panel in certain temperature and irradiation conditions, while also contributing to optimally solving the energy balance problems previously discussed.

According to further aspects of the present invention, similarly to what can be done in order to re-configure in a flexible manner the series-parallel connections of a modular direct-current electric energy production system, one can also re-configure the connections of a storage system SAE. In fact, most storage systems are characterized by being made up of elementary modules which are generally connected in a fixed manner so as to have at their terminals a roughly constant voltage and to be able to output the rated power. However, for application downstream of a photovoltaic system, even an SAE can be conveniently implemented in such a way as to have a flexible configuration of its internal connections and to accept different charge voltages and currents.

Therefore, by modifying the series-parallel connections of both the FER and the SAE, while being able to partition both the FER and the SAE, energy management can be suitably optimized.

The invention teaches how to make such configurations by simply resorting to switches that can be controlled by a computer or controller executing switch control programs and other programs implementing algorithms known per se, for searching the optimum operating conditions, wherein the function to be optimized may be a technical or an economical one. It should be observed that, the larger the number of FER and SAE elements, the more refined are the searches for the optimum coupling between the various elements.

In short, it is now apparent that a FER can also be connected to an SAE, in addition to an inverter, without going through DC-AC and AC-DC conversion stages, simply by appropriately configuring the series-parallel configurations of the FER and of the SAE so as to make the FER output voltage as close as possible to the optimal input voltage for SAE charging. As far as currents are concerned, the problem appears to be less critical in that the SAE can generally accept a wider current range; in general, it is essential that the minimum current capable of triggering the charge process is available, while excessive currents might overheat the battery and reduce efficiency of the latter, or even, in the worst case, cause damage to it. For very low production values, i.e. involving low currents, it is conceivable to charge just a few modules of the SAE, even just one module at a time, and then let the coupling operate even with a very low current, if we consider that SAE's may be very granular systems composed of tens, or hundreds, of elementary modules.

The SAE's are normally of the electrochemical type, whether they are classic lead or gel batteries or electrolyte circulation systems, or other accumulation systems of different types.

In any case, one can exploit the fact that the SAE's are made up of a certain number of elementary cells or modules which are connected in series and in parallel to appear as a system with just one pair of input/output terminals. By connecting the various modules in series with one another, a circuit is obtained which has a higher voltage across its terminals; then, by connecting the series circuits in parallel to one another, a circuit is obtained which can absorb/output increasingly high currents as the number of circuits connected in parallel grows.

Furthermore, the possibility of controlling a suitable set of switches with absolute flexibility, allows using only some portions of the SAE. This is very useful especially when very low energy values are involved during the charging process.

It follows that all the flexible connection schemes of the various FER modules previously illustrated are also applicable to the elements of energy storage systems. One example of embodiment of interconnections among SAE modules will now be described.

When coupling a FER to an SAE, since both the SAE input voltage and the FER output voltage can be controlled, it is generally possible to find those combinations which are closest to the optimal solution.

For both SAE's and FER's, in addition to flexibly combining the series/parallel connections, it is important to provide sectionability. For example, for particularly low values of produced energy to be stored, it is physically possible to charge only some elements of the SAE or, the different SAE elements being at a different state of charge, one can carry out selective discharge or charge operations.

The present invention allows to implement an additional functionality that can be executed locally within a “Smart Grid”. Said functionality is independent of the hardware choices concerning the computers used for controlling the “Smart Grid”, and solves the problems of DC adaptation of the various parts of the systems (FER—SAE—inverter) while optimizing the distribution of the available energy (from FER or from SAE).

Therefore, the present invention solves problems of DC adaptation among the various parts of the system as well as problems of management of the energetic resource through a controller, which may be either a dedicated device or a function executed by one of the various computers certainly included in the “Smart Grid”.

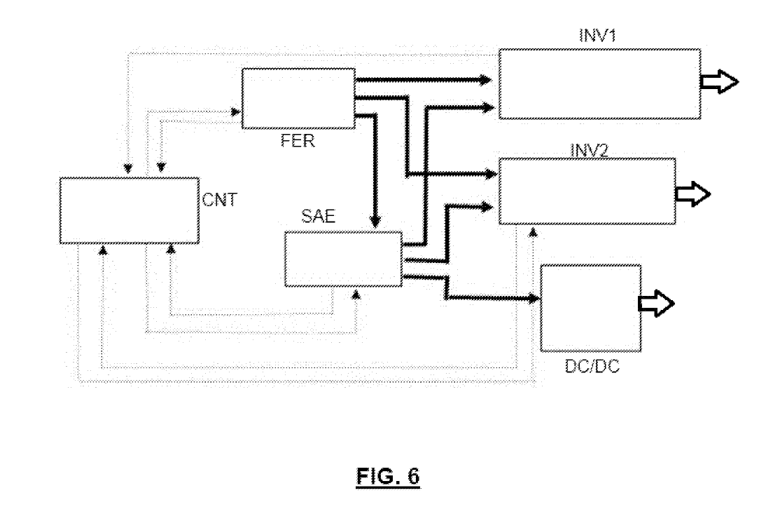

FIG. 6 shows the main elements of the system, which comprises at least one FER, at least one SAE, and at least one controller CNT. FER and SAE are located upstream of the DC/AC conversion systems, which comprise at least one inverter system INV1 directed towards external loads, such as the public electric energy distribution network, and/or at least one inverter system INV2 directed towards local internal loads, such as the domestic power network.

The example of FIG. 6 shows two load networks because this is the most typical case, in that it is useful to discern between private loads, which can be managed with “Smart Grid” criteria and can be associated in a privileged way with the FER, e.g. for private use, and generic external loads connected to an external or public network. Actually there could be any number of load networks.

The dashed lines indicate exchanges of information and/or commands, whereas the continuous lines represent flows of electric energy. In particular, there is a bidirectional exchange of information and/or commands between the controller CNT and FER, SAE and INV2 (e.g. relating to power availability forecasts or for diagnostic purposes), while the controller CNT can generally only receive information from the external network through the inverter INV1 (e.g. it can receive information about the price at which the network is willing to buy or sell any available energy). FER can supply energy flows to SAE and to the inverters INV1, INV2. SAE can receive energy to be stored from FER and can supply energy to the inverters INV1, INV2.

Of course, the public network may also receive commands and information from the controller CNT. Moreover, it is also possible to manage a flow of energy from an external network to SAE: this option could be useful for purchasing energy at a favorable price, within suitable time intervals, which could be used at peak times, for example, when the price of energy is highest and FER cannot produce sufficient energy.

Furthermore, the SAE may also be configured in a manner such that it supplies different voltage values to predetermined outputs, which may possibly be re-configured by the controller and used by local loads operating at direct voltage and/or by DC/DC converters which adapt the voltage levels generated by the SAE for such loads. This increases efficiency in that it eliminates or at least reduces the energy dissipation due to the DC/AC conversion carried out by the inverters and to the next conversion carried out by the power supplies of DC apparatuses (such as mobile telephones, notebooks, battery chargers, etc.). The exchange of information between the controller CNT and the inverters INV1, INV2 may take place on an Ethernet bus, whereas the exchange of information between the controller and the FER and between the controller and the SAE may take place over “conveyed waves”. It is possible that large SAE's are already equipped with their own controller, which carries out a number of system management functions; in such a case, also the communications between the controller CNT and the SAE controller may take place on an Ethernet bus, while “conveyed waves” may be used for transporting the switch control information between the SAE controller and the switches.

Also the FER's may be associated with a specific controller that communicates with the controller CNT on an Ethernet bus, the commands being then transmitted to the FER switches over “conveyed waves”.

The FER and SAE controllers can be seen as extensions of the controller CNT, and therefore the controller CNT will always be meant when mentioning the communications between controller and SAE and between controller and FER.

As for the communications taking place on an Ethernet bus, this means that communication occurs between computers, and therefore it can be managed by using any commonly known technique: for example, also a WiFi connection or an M2M technique.

A typical example of utilization of a network like the one described with reference to FIG. 6 will now be taken into account.

The example concerns the production obtained at a generic instant T1 by a FER consisting of a modular direct-current electric energy production system made up of N panels.

At said instant T1, the FER is making available a power value Pf1, while the internal load network is requiring a power value Pc1, where Pc1<Pf1.

The controller CNT is connected to the network inverter INV1 and to the local inverter INV2, and can exchange information therewith. In the simplest case, it exchanges information on an Ethernet bus.

The controller CNT is also connected to all pairs of I/O terminals of the FER and of the SAE. On said terminals, it can take direct current and voltage measurements, and can transmit the commands required for configuring both the FER and the SAE over “conveyed waves”.

In the case considered herein (Pf1>Pc1), in one possible operating mode the controller delivers a part of Pf1 equal to the requirement Pc1 to the output connected to the inverter INV2. In addition, the controller combines the series-parallel connections of the FER in a manner such that at the output connected to the inverter INV2 there is a current-voltage profile that optimizes the performance of the conversion elements.

The remaining power produced by the FER (Pf1−Pc1) is all made available at the output connected to the SAE. In this case, the controller CNT will take care of configuring both the SAE modules and the FER modules in a manner such that the SAE can ensure the best storage efficiency. For example, if excess power is not much, it may be advantageous to activate only a part of the battery modules at the SAE charge input, so that it will be necessary to configure also that part of the FER modules that produce excess energy in such a way as to create, in the FER-SAE connection, the appropriate current-voltage characteristic that optimizes storage efficiency.

If the storage system is already fully charged, the excess power can be made available to the FER output connected to the external network by means of the inverter INV1. Such a choice may also be made when, for example, the external network needs energy. Therefore, the controller CNT, also on the basis of the available information about internal demand and network demand, may decide to yield the excess energy to the public network, instead of storing it.

It is clear at this point that the controller CNT may be very useful should “Smart Grids” become widespread. In fact, said controller will have all information necessary for optimizing the divisions and adaptations required for the energy exchanges between FER, SAE and loads of different nature.

In this way, one can properly manage the quantities of energy exchanges in the various directions and any current-voltage adaptations without having to use any AC-DC and DC-AC conversion apparatuses which are not strictly necessary. As a matter of fact, all these adaptations can be carried out by means of switches, thus reducing the losses and inefficiencies due to conversions.

The typical case that the prior art is trying to handle by introducing flexible configuration techniques relates to production obtained from photovoltaic systems, wherein some panels may occasionally be shaded and their output may drastically drop in comparison with the other unshaded panels. As aforementioned, this case is normally handled by disconnecting the whole array that includes such panels, thus implying a waste of energy.

It is already known in the art to provide the panels with sensors detecting any anomalous conditions, such as shading or damage. In accordance with the present invention, the controller CNT can detect such anomalies simply through readings at the panels' terminals, and then it can re-configure the FER in a flexible manner by isolating only the panels involved, not the whole arrays.

Some more detailed examples of embodiment of the system according to the invention will now be described.

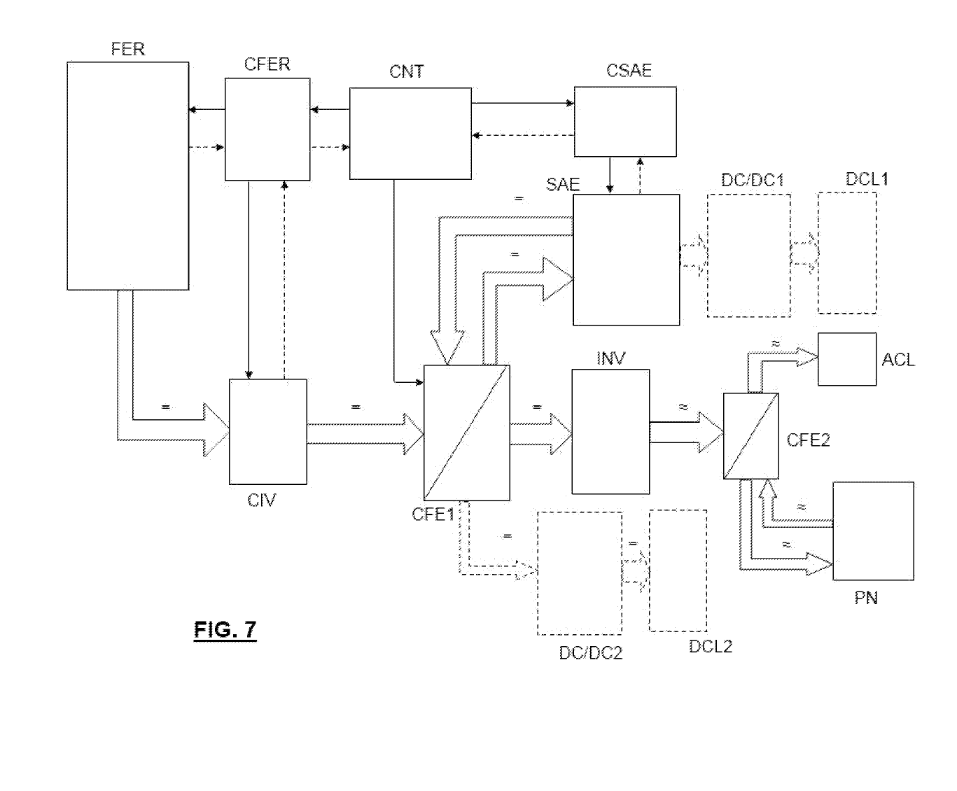

FIG. 7 shows in more detail an example of embodiment of the system of FIG. 6.

The storage system SAE may be coupled directly to DC loads DLC1 through a suitable direct-current converter DC/DC1, and/or indirectly to the same or other DC loads DLC2 through another direct-current converter DC/DC2. Indirect coupling occurs through an energy flow switch EFC1, which receives at its inputs energy coming from FER and SAE, and which, when appropriately controlled by CNT, supplies electric energy to the inverters INV1, INV2 (FIG. 6) and/or to said direct-current converter DC/DC2. The inverters INV1, INV2 may also be implemented through an inverter system INV (FIG. 7), followed by an electric energy flow switch directed to local AC loads ACL and/or to the public network PN, from which electric energy may also be introduced, as previously described.

The controller CNT receives, whether directly or through switching control units, information about the state of FER and SAE as well as about the voltage-current output conditions of the FER. More in particular, as already mentioned, the FER panels are equipped with sensors detecting the operating and voltage-current output conditions: these data are supplied to a module CIV which, being suitably controlled by CNT, can determine the FER configuration conditions through a control unit CFER, which is also directly controlled by CNT.

As needed, the energy coming from FER, through the module CIV, is conveyed by the controller EFC1 towards the inverter INV and/or the SAE and/or directly the DC load DCL2.

The controller CNT also receives information about the state of the energy storage modules that make up the SAE through the control unit CSAE, to which the sensors detecting the operating conditions of the SAE modules are connected. Also this information is used by CNT to determine the optimal SAE configuration.

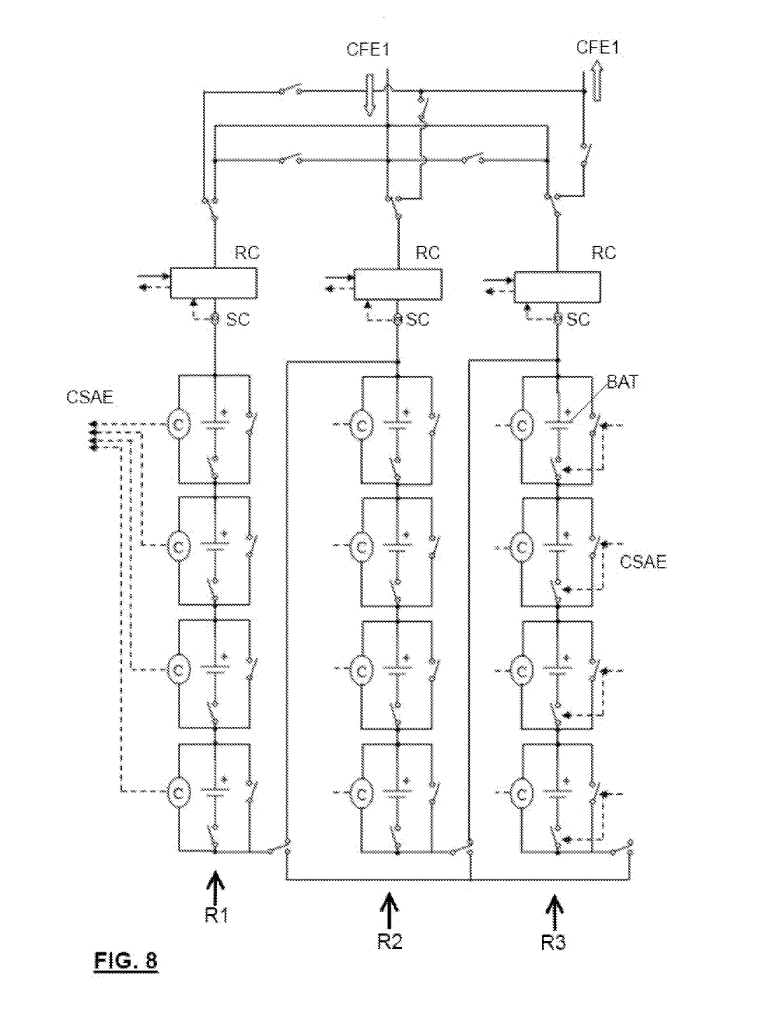

With reference to FIG. 8, there is shown a possible SAE configuration which comprises a given number of storage cells or units (normally batteries BAT), organized into branches or arrays R1, R2, R3. Each cell includes a charge sensor C and switches controlled by the CSAE module, which can connect the various cells in series to other cells of the same branch, or otherwise disconnect them. Other switches, controlled by the CSAE module, can connect the various branches in series or in parallel, or otherwise disconnect them. The charge sensors C provide the CSAE module with indications about the state of the cells. Based on the instantly available voltage and current, one or more SAE cells may be charged.

Each SAE branch has one current sensor SC connected to a current regulator RC, which in turn is connected in a bidirectional manner to the energy flow switch CFE1, thereby allowing to control the current and, for example, to prevent it from exceeding a certain predefined value in order to avoid damaging the branch cells during the charge process. With the configuration shown in the drawing, it is even possible to charge some cell arrays and to drain energy from other cell arrays at the same time, if the latter have been fully charged, so as to supply power to a local DC load or even, after passing through the inverter, to an AC load, thus giving great flexibility of use to the system.

This considerably increases the likelihood that the system will deliver energy to user apparatuses even in the complete or partial absence of solar light, thus significantly reducing the dependency on the electric distribution network. The switch control units of the FER and of the SAE may also be integrated therein or into the controller. Several arrays in parallel may be charged or used in the case wherein higher currents are produced or drawn than those that can be absorbed or generated by a single array.

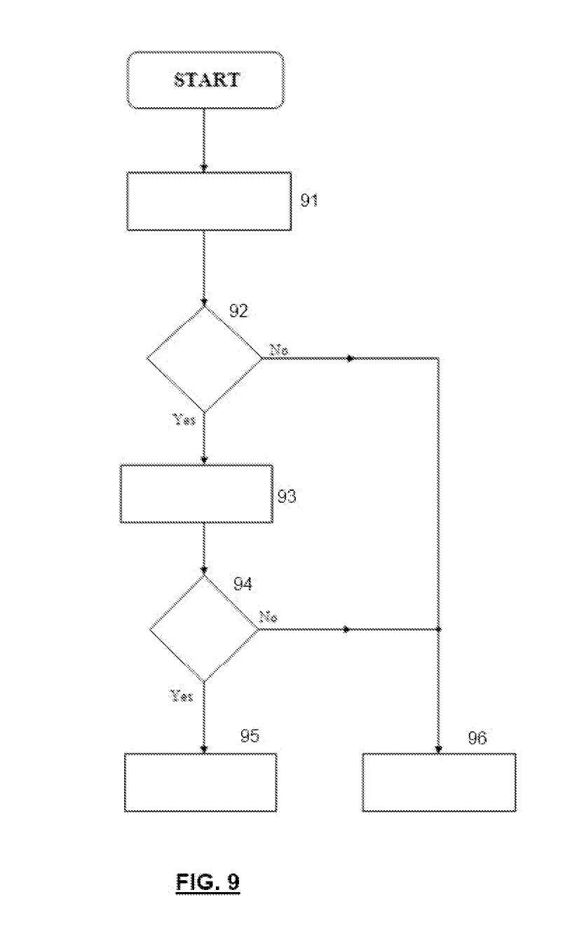

The decision-making process carried out by the controller CNT in relation to the operating state of the system is shown in the flow chart of FIG. 9. The controller acquires from the CIV unit the energy generation state of FER (block 91). If the inverter INV cannot be activated (block 92), all the energy that can be drained from FER is transferred to SAE (block 96). Otherwise, it is verified if the network can absorb the energy generated by FER and/or if it is convenient to transfer it immediately because the sale price is favorable, and/or if the local loads do not need it and/or the battery is fully charged (block 93). If the verification gives a positive result (block 94), then the FER energy is transferred to the network (block 95), otherwise it is conveyed towards SAE (block 96).

The flow chart of FIG. 9 can be implemented in various equivalent forms. It may be implemented through a cyclic repetition of a group of instructions, through interrupt mechanisms coming from decentralized control units that verify the decision-making conditions, through mechanisms by means of which the controller polls (periodically interrogates) peripheral apparatuses, and so on. It may be implemented in automatic form or in a form partially or totally programmable through, for example, a timer, and/or in manual form through commands entered by a human operator.

The controller CNT is able to verify the energy generation state of the FER, the absorption capacity of the network, the charge capacity of the SAE modules, the actual or expected current consumption of the local loads, and then can decide which energy transfer policy to adopt, also on the basis of parameters programmed by the operator (profit maximization, maximum continuity of supply to local loads, maximization of the battery charge state, etc.).

In the case of generic module heterogeneity, it is necessary that the controller knows the instantaneous production of each module. This can be ensured, for example, by fitting each FER module with a device that, through commercially available sensors, e.g. installed on the modules themselves, measures production data and sends them to the controller.

The controller may however also take readings autonomously, without needing additional sensors in the modules, e.g. by taking measurements at the anode and cathode terminal pairs of the modules while appropriately setting the switches of each module. In fact, the controller can execute programs that, starting from the available readings and from the knowledge of the system (module specifications, number of modules, module type, module orientation, expected efficiency, etc.), make estimates and evaluations which allow to apply algorithms for searching the optimal module connection configurations, and possibly also to disconnect some of them, for the various reasons already described.

The control system of the present invention can advantageously be implemented through a computer program, which comprises coding means for implementing one or more steps of the method when said program is executed by a computer. It is therefore understood that the protection scope extends to said computer program as well as to computer-readable means that comprise a recorded message, said computer-readable means comprising program coding means for implementing one or more steps of the method when said program is executed by a computer.

The above-described non-limiting examples may be subject to variations without departing from the protection scope of the present invention, including all equivalent embodiments known to a man skilled in the art.

The advantages deriving from the application of the present invention have already been described above.

In conclusion, the system solves many problems related to the integration of variably sized “islands” or “energy districts” including FER's, SAE's and local loads, while optimizing the connections and the methods of subdivision of the energy flows. All this is achieved by only adding some simple switches, which can be integrated, among other things, into the existing FER and SAE modules, thereby allowing the controller to manage and solve all problems related to the coupling and partitioning of the different productions, thus avoiding any unnecessary DC/AC and AC/DC conversions and optimizing the efficiency of the FER and of the SAE. In fact, the management part is entrusted to controllers which would in any case be used for governing the “energy district” or “island”, as required by the evolution of electric networks in accordance with the “Smart Grid” concepts.

From the above description, those skilled in the art can produce the object of the invention without introducing any further construction details.

1. A system for generating and using (for storage and supply of) electric energy produced by modular direct-current electric energy sources, comprising:
a system of interconnected modules for the production of direct-current electric energy, said system of interconnected modules being positioned upstream of one or more DC/AC conversion systems;
a system of interconnected elements for the accumulation and supply of electric energy produced by said electric energy production modules, said system of interconnected elements being positioned upstream of said one or more DC/AC conversion systems;
at least one electronic control unit, adapted to configure in a variable manner the interconnections among said modules and the interconnections among said elements so that at least some of said interconnected modules can deliver electric energy directly to at least some of said accumulation and supply elements, and/or to said one or more DC/AC conversion systems, and so that at least some of said elements can supply electric energy directly to said one or more DC/AC conversion systems.

2. A system according to claim 1, wherein said at least one electronic control unit is configured in a manner such that said system of interconnected elements supplies electric energy directly to systems using direct-current electric energy, possibly via a DC/DC conversion.

3. A system according to claim 1, wherein said at least one electronic control unit is so configured as to determine the voltage and current at the outputs of said system of interconnected modules and at the outputs and inputs of said system of interconnected elements, determining the series and/or parallel interconnection configurations of said modules and said elements.

4. A system according to claim 1, wherein said system of interconnected modules for the production of electric energy comprises:
two or more of said modules, each module comprising an anode terminal and a cathode terminal;
at least one first electric line connected to an anode terminal and a cathode terminal of the system;
first electric switching means, at least one of which is arranged at each of said modules, said first electric switching means being so configured as to connect said anode and/or cathode terminals of one module to anode and/or cathode terminals of another module, or to said first electric line, or to disconnect one or more modules from the system, upon commands issued by said at least one electronic control unit.

5. A system according to claim 4, wherein said system of interconnected modules for the production of electric energy comprises two or more first arrays, each array comprising one of said first electric lines, said at least one electronic control unit comprising means for determining parallel connections among said first arrays, or for subdividing groups of first arrays in parallel.

6. A system according to claim 1, wherein said system of interconnected elements for the accumulation and supply of electric energy comprises:
two or more of said elements, each element being fitted with an anode terminal and a cathode terminal;
at least one second electric line connected to an anode terminal and a cathode terminal of the system;
second electric switching means, at least one of which is arranged at each of said elements, said second electric switching means being so configured as to connect said anode and/or cathode terminals of one element to anode and/or cathode terminals of another element, or to said second electric line, or to disconnect one or more elements from the system, upon commands issued by said at least one electronic control unit.

7. A system according to claim 6, wherein said system of interconnected elements for the accumulation and supply of electric energy comprises two or more second arrays, each second array comprising one of said second electric lines, said at least one electronic control unit comprising means for determining parallel connections among said second arrays, or for subdividing groups of second arrays in parallel.

8. A system according to claim 4, wherein said at least one electric line is also fitted with an array line, and wherein said switching means are so configured as to connect the corresponding panel to said array line in order to establish a series connection with at least another panel, upon a command issued by said at least one electronic control unit.

9. A system according to claim 8, wherein each one of said two or more modules comprises at least one electric input and at least one electric output, and wherein said switching means comprise at least one input switch and at least one output switch, said input and output switches being so configured as to connect said electric line to said electric input and to said electric output, respectively, upon a command issued by said at least one electronic control unit.

10. A system according to claim 9, wherein said switching means comprise at least one third switch so configured as to close said array line when said input and output switches of the corresponding module are open, thus disconnecting the corresponding module, or else to open said array line, upon a command issued by said at least one electronic control unit.

11. A method for managing said system according to claim 1, comprising the steps of:
interconnecting each one of said electric energy production modules with other modules, and/or disconnecting one or more of said modules, by operating said first switching means by means of said at least one electronic control unit;
interconnecting each one of said electric energy accumulation and supply elements with other elements, and/or disconnecting one or more of said elements, by operating said second switching means by means of said at least one electronic control unit.

12. A method for managing said system according to claim 11, comprising the step of interconnecting said first and/or second arrays in parallel and/or isolating groups of said first and/or second arrays, by operating said first and/or second switching means on said at least one first and/or second electric line by means of said at least one electronic control unit.
